(19) United States
(12) Patent Application Publication
(10) Pub. No.: US 2010/0114860 A1
(43) Pub. Date: May 6, 2010

(54) APPARATUS FOR SEARCHING INTERNET-BASED INFORMATION

(75) Inventors: Key-Sun Choi, Daejeon (KR); JinHyun Ahn, Daejeon (KR)

Correspondence Address: BACHMAN & LAPOINTE, P.C., 900 CHAPEL STREET, SUITE 1201, NEW HAVEN, CT, 06510, US

(73) Assignee: KOREA ADVANCED INSTITUTE OF SCIENCE AND TECHNOLOGY, Daejeon (KR)

(21) Appl. No.: 12/388,816

(22) Filed: Feb. 19, 2009

(30) Foreign Application Priority Data
Oct. 17, 2008 (KR) 10-2008-0101980

(51) Int. Cl. G06F 17/30; G06F 7/06; G06F 15/16; G06F 7/00

(52) U.S. Cl. 707/709; 709/245; 709/219; 707/E17.108; 707/E17.032; 707/E17.044; 707/E17.017

(57) ABSTRACT

The present invention relates to an Internet-based information search apparatus for searching for information by accessing web resources through the Internet using both a method of representing the identifier of a web resource and the identifier.

The Internet-based information search apparatus includes an ROAR name server for managing a resource name and a URL corresponding to the resource name, and transmitting URL information corresponding to contextual information, which contains the resource name, to a domain name server when the contextual information is received, the domain name server for receiving the URL information and then transmitting an IP address corresponding to the URL information to the ROAR name server; and an input module for receiving the contextual information, transmitting the contextual information to the ROAR name server through a web browser, receiving the IP address from the ROAR name server, and requesting corresponding information from a web server.

### BACKGROUND OF THE INVENTION

1. Field of the Invention

The present invention relates, in general, to an Internet-based information search apparatus, and, more particularly, to an apparatus for searching for information by accessing a web resource through the Internet using both a method of representing the identifier of the web resource and the identifier.

2. Description of the Related Art

A Uniform Resource Locator (URL) used in Hypertext Transfer Protocol (HTTP) is an identifier which represents information about the location of a web document [Document 1]. Such a URL uses the following grammar.

http://<host>:<port>/<path>?<searchpart>

Generally, in the <host> part, the domain name of a computer having a given document is described. This domain name is converted into an Internet Protocol (IP) address by a Domain Name System (DNS), and thus enables access to a relevant host. In the <port> part, a port number used by a relevant web server program is described, and in the <path> part, the path of the relevant document is described. In the <searchpart> part, additional information to be transmitted using HTTP is described.

Friend of a Friend (FOAF) is an ontology for representing information about persons and information about relationships therebetween in a machine-readable form [Document 2]. When the FOAF document of a specific person is analyzed, acquaintances of the person and acquaintances of the acquaintances, as well as information about the person, can be known. That is, FOAF is a method of representing a relational network between persons in a machine-readable form on the web.

[Document 1] RFC 1738,

http://www.faqs.org/rfcs/rfc1738.html [on-line], 1994. 12. (date of search: 2008. 06. 09)

[Document 2] FOAF project, http://www.foaf-project.org/ [on-line], (date of search: 2008. 06. 09)

In two aspects, the problems of the current technology are described below.

First, when two web documents in which the same information is described are open to the public by different web servers, the URLs of the respective documents are different from each other, and thus a typical search engine processes two documents as different documents. Therefore, there is a high possibility that both documents show up in a list of search results. Since a user desires to sufficiently display suitable information on one screen, such a search result list may not be useful. The reason for this is that web documents containing similar information repeatedly show up in the list. In order to solve this problem, a method in which a search engine individually analyzes the content of documents and sorts similar documents may be used. However, in such a method, it is inefficient for a search engine to analyze a great number of documents existing on the web.

Second, when the URL of a specific web resource R, open to the public on the web, changes from addr1 to addr2, addr1 is still recorded as a link in a Hypertext Markup Language (HTML) document D having a link to R, and thus a link enabling access to R is lost. Until the changed URL (addr2) is explicitly known, a link (addr1), which is not currently present, remains in document D. A method in which an HTML document manager or program periodically checks whether a link recorded in a relevant HTML document is accessible may be used, but it is inefficient to manage all HTML documents complicatedly connected to each other using such a method. Further, a URL forwarding method may be used, but this is not a fundamental solution in the situation in which various types of web resources is rapidly increasing.

This problem occurs because a URL is an identifier for representing a location. Accordingly, a method of representing instead of the location information of the web resources, the content of web resources and the relationship therebetween in the identifiers of web resources is required.

### SUMMARY OF THE INVENTION

Accordingly, the present invention has been made keeping in mind the above problems occurring in the prior art, and an object of the present invention is to provide an Internet-based information search apparatus, which represents instead of location information of the web resources, the content of web resources and relationships therebetween in the identifiers of the web resources in order to solve the problems occurring when a URL, a location representation identifier, is used in a conventional Internet-based information search apparatus.

In order to accomplish the above object, the present invention provides an Internet-based information search apparatus, comprising a Resource Of A Resource (ROAR) name server for managing a resource name and a Uniform Resource Locator (URL) corresponding to the resource name, and transmitting URL information corresponding to contextual information, which contains the resource name, to a domain name server when the contextual information is received; the domain name server for receiving the URL information and then transmitting an Internet Protocol (IP) address corresponding to the URL information to the ROAR name server; and an input module for receiving the contextual information, which contains the resource name, transmitting the contextual information to the ROAR name server through a web browser, receiving the IP address from the ROAR name server, and requesting corresponding information from a web server.

Preferably, the ROAR name server may comprise a URL information conversion module for receiving a resource name from a user and converting the resource name into URL information.

Preferably, the resource name may include a protocol part in which ‘roar’, or a symbol and alphabet letters corresponding to ‘roar’ are represented, and a symbol ‘/’.

Preferably, the contextual information may be profile information of a user, or an electronic document previously created by the user.

Preferably, the ROAR name server may comprise a resource name table in which information about mapping between a resource name and a plurality of URLs corresponding to the resource name is stored.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the operating process of an Internet-based information search apparatus according to the present invention, wherein portions indicated by solid lines are modules compatible with Hypertext Transfer Protocol (HTTP), and portions indicated by dotted lines are modules compatible with ROAR protocol;

FIG. 2 is a diagram showing an example of an ROAR name table included in the ROAR name server of the Internet-based information search apparatus according to the present invention;

FIG. 3 is a diagram showing an example of an ROAR triplet table included in the ROAR name server of the Internet-based information search apparatus according to the present invention; and

FIG. 4 is a diagram showing a process in which an HTML document creator registers/updates an ROAR name table and an ROAR triplet table in the Internet-based information search apparatus according to the present invention.

### DESCRIPTION OF THE PREFERRED EMBODIMENTS

Hereinafter, embodiments of the present invention will be described in detail with reference to the attached drawings.

The present invention uses a method of representing a name identifier, in which the content of web resources is reflected, without representing location information such as a domain name in a URL, thus solving the above conventional problems. A Resource Of A Resource (ROAR) proposed in the present invention is a protocol modified from HTTP, and uses an ROAR identifier (ROAR name) other than a URL which is a location information-based identifier.

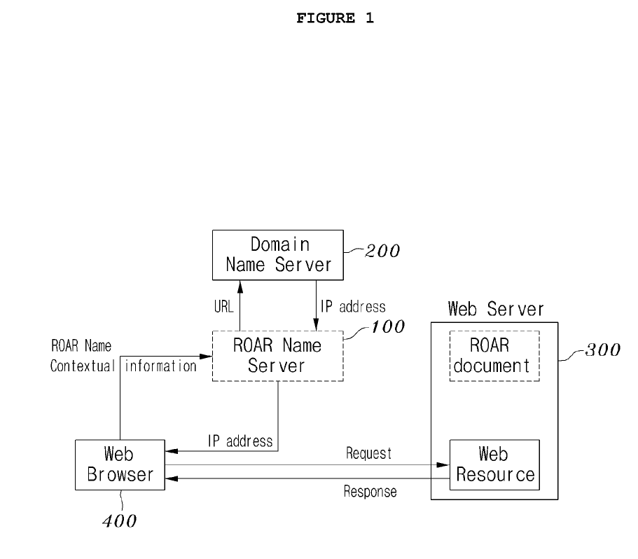

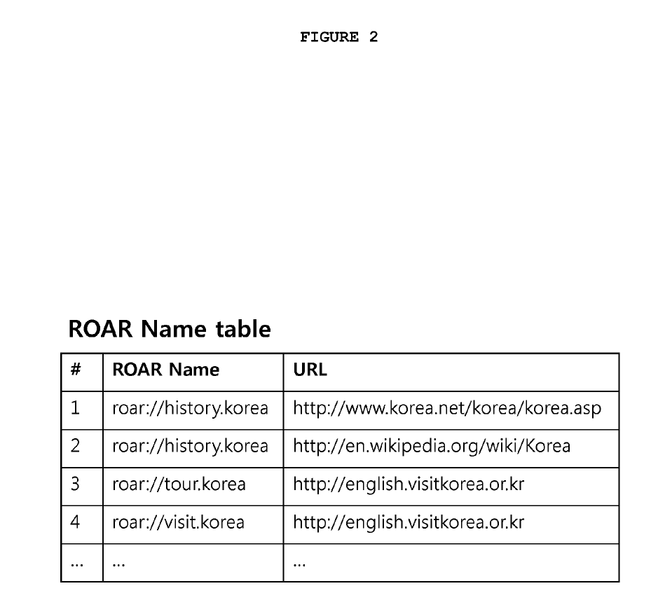

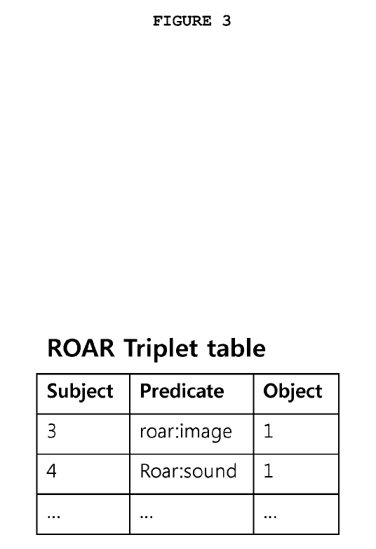

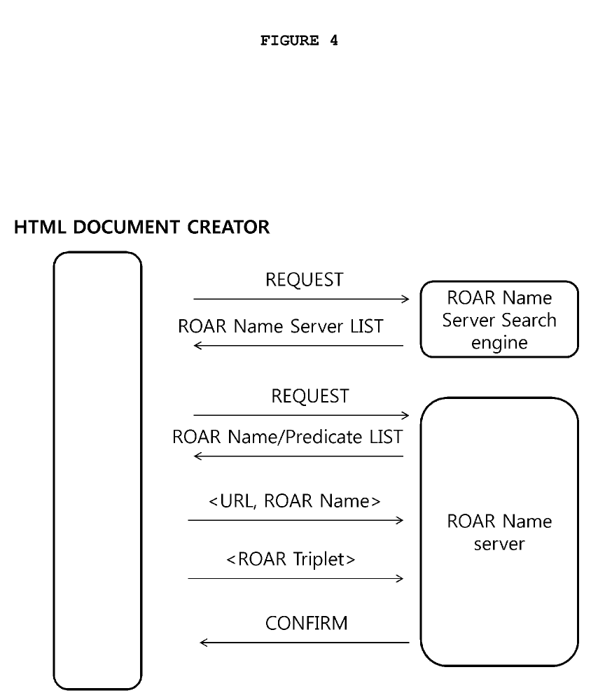

FIG. 1 is a diagram showing the operating process of an Internet-based information search apparatus according to the present invention, wherein portions indicated by solid lines are modules compatible with Hypertext Transfer Protocol (HTTP), and portions indicated by dotted lines are modules compatible with ROAR protocol, FIG. 2 is a diagram showing an example of an ROAR name table included in the ROAR name server of the Internet-based information search apparatus according to the present invention, FIG. 3 is a diagram showing an example of an ROAR triplet table included in the ROAR name server of the Internet-based information search apparatus according to the present invention, and FIG. 4 is a diagram showing a process in which an HTML document creator registers/updates an ROAR name table and an ROAR triplet table in the Internet-based information search apparatus according to the present invention.

As shown in FIG. 1, the Internet-based information search apparatus according to the present invention includes an ROAR name server 100, a Domain Name Server (DNS) 200, a web server 300, a web browser 400, and an input module (not shown).

The ROAR name server 100 manages a resource name and a Uniform Resource Location (URL) corresponding to the resource name. When contextual information, containing the resource name, is received, the ROAR name server 100 transmits URL information corresponding to the contextual information to the domain name server 200. The ROAR name server 100 may include a URL information conversion module (not shown) for receiving a resource name from a user and converting the resource name into URL information. Further, the ROAR name server 100 may include a resource name table in which information about mapping between a resource name and a plurality of URLs corresponding thereto is stored. Meanwhile, such a resource name includes a protocol part, in which ‘roar’, or a symbol and alphabet letters corresponding to ‘roar’ are represented, and a symbol ‘/’.

The domain name server 200 receives the URL information from the ROAR name server, and then transmits an IP address corresponding to the URL information to the ROAR name server.

The web server 300 is a server for storing web resources, meta information about the web resources, ROAR documents, etc. The web server 300 periodically exchanges ROAR packets with the ROAR name server 100, thus enabling resource names and URLs corresponding thereto to be periodically updated.

The input module (not shown) receives the contextual information, containing a resource name desired to be searched for, transmits the contextual information to the ROAR name server through the web browser 400, receives the IP address from the ROAR name server, and requests corresponding information from the web server.

The resource name (ROAR name) input by the user via the web browser 400 is transferred to the ROAR name server 100 and is converted into a URL, and then the URL is transferred to the DNS.

A URL into which an ROAR name is to be converted is preset and defined in the ROAR name table of the ROAR name server. That is, in the ROAR name table, information (A→C) indicating that the ROAR name A must be converted into the URL C is recorded in advance. This information is defined by an HTML document creator corresponding to the URL after permission has been obtained from the ROAR name server. The DNS converts the given URL into an IP address, thus allowing the web browser 400 to access a desired web resource over the Internet.

The current DNS performs management by mapping a unique IP address to a given domain name (URL), but the ROAR name server performs management by mapping a plurality of URLs to a given ROAR name. A URL to be selected from among the plurality of URLs is determined by combining the contextual information provided by the user with the relationship information between the respective ROAR names. The contextual information may be the profile information of the user or any document personally described by the user.

Since different ROAR names and relationship information therebetween are managed by respective ROAR name servers, a means for allowing the user to select a desired ROAR name server is required. When there is an ROAR name server search engine for indexing information about respective ROAR name servers and helping the user select an ROAR name server suitable for himself or herself, the user may select and use a suitable ROAR name server according to the circumstances.

The grammar of ROAR names is identical to that of current URLs. In actual representation, ‘roar’ is represented in a protocol part, and a host part (the domain name) is omitted because it is not necessary. For example, an ROAR name for Seoul subway can be presented using the following form:

roar: //korea/seoul.subway

The case where ‘/’ is to be used and the case where is to be used are determined by the ROAR name server. Since ROAR is an Internet protocol similar to HTTP, host information (URL or IP address) is required so as to access a remote web document. Since host information is not represented in an ROAR name, it must be stored in some other place. The ROAR name server is a server system for managing ROAR names and URLs corresponding thereto, and performs a function similar to that of the current DNS. When the user inputs an ROAR name through the web browser, the ROAR name is transmitted to the ROAR name server. As in the case where the IP address of the DNS is designated in advance through the computer of the user, the IP address of the ROAR name server must be set in advance. However, since the ROAR name server provides more functions than does the DNS, pieces of information provided by respective ROAR name servers may differ. Therefore, an ROAR name server search engine for searching for an ROAR name server suitable for the user is required. The number of ROAR name servers is much smaller than that of web documents. Therefore, from the standpoint of the user, a method of using the ROAR name server search engine or a process for finding desired results from among the results of a search is relatively easier than that using the current web document search engine. For example, a procedure for searching for an ROAR name server which includes a larger number of ROAR names related to the fields of interest to the user, setting the IP address of the ROAR name server in the web browser, and searching for information using the web browser, may be used.

The ROAR name server manages an ROAR name table and an ROAR triplet table and periodically updates them. As shown in FIG. 2, the ROAR name table includes information such as ROAR names and URLs. Such a URL is a web document identifier used in current web standards. As shown in FIG. 3, the ROAR triplet table includes ROAR triplets. Such an ROAR triplet is a structure in which relationship information between ROAR Names is represented in the form of a triplet (subject, predicate and object). Both the subject and object of an ROAR triplet indicate ROAR names, and the predicate indicates previously defined relationship information and has a form of roar:<relationship information>. The relationship information is a word capable of describing the relationship between two ROAR names. For example, <1><roar:image><2> symbolizes that “an image of ROAR name 1 is present in ROAR name 2”.

As shown in FIG. 4, the ROAR name table and the ROAR triplet table are registered/updated at the request of an HTML document creator. A process in which the HTML document creator registers/updates an ROAR name table and an ROAR triplet table is described below. First, the HTML document creator requests a list of ROAR name servers suitable for the topic of his or her web document from the ROAR name server search engine. On an ROAR name server determined to be suitable for the topic among the ROAR name servers, the following steps are performed. First, the HTML document creator requests both a list of ROAR names and a list of ROAR predicates, which are provided by the ROAR name server, from the ROAR name server. The HTML document creator selects an ROAR name which is determined to be suitable for his or her web document from the list of ROAR names, and transmits the selected ROAR name to the ROAR name server together with the URL of the web document. Further, the HTML document creator transfers an ROAR triple, which describes the relationship between the ROAR name, previously present in the ROAR name server, and his or her web document, to the ROAR name server. The manager of the ROAR name server manually selects only suitable information from among pieces of information requested by the user, registers the selected information both in the ROAR name table and in the ROAR triplet table, and notifies the user of the current situation of the registration (refer to FIG. 2).

Referring to FIG. 2, third and fourth rows of the ROAR name table represent examples in which the HTML document creator, who wrote a document at “http://english.visitkorea.or.kr”, registers two ROAR names “roar://tour.korea” and “roar://visit.korea”, and one ROAR triple “<roar://tour.korea,roar:image,roar://history.korea>”.

In accordance with the above-described Internet-based information search apparatus, the following two advantages can be obtained. First, since web resources can be easily classified according to information described by resources when ROAR name servers are used, the probability that repeated information will show up in a list of search results decreases. Further, the relationships between respective web resources are managed by ROAR name servers, and the relationships between respective web resources are described in ROAR documents. Accordingly, from the standpoint of a search engine, it is possible to easily find web resources related to a web document without analyzing content of the web document. Second, since a plurality of URLs corresponds to one ROAR name, the probability that a user will view an error message such as “Page Not Found” is reduced. The occurrence of less error when implemented in this way means that a necessity for an HTML document creator to check whether a linked document is accessible is reduced. The reason for this is that only an accessible URL needs to be dynamically selected from among a plurality of URLs corresponding to the ROAR name described in the HTML document.

As described above, the Internet-based information search apparatus according to the present invention has the following advantages.

First, since web resources can be easily classified according to information described by resources when ROAR name servers are used, the probability that repeated information will show up in a list of search results decreases. Further, the relationships between respective web resources are managed by ROAR name servers, and the relationships between respective web resources are described in ROAR documents. Accordingly, from the standpoint of a search engine, it is possible to easily find web resources related to a web document without analyzing content of the web document. From the standpoint of a user, it is possible to view search results having no repeated information.

Second, since a plurality of URLs corresponds to one ROAR name, the probability that a user will view an error message such as “Page Not Found” is reduced. The occurrence of less error when implemented in this way means that a necessity for an HTML document creator to check whether a linked document is accessible is reduced. The reason for this is that only an accessible URL needs to be dynamically selected from among a plurality of URLs corresponding to the ROAR name described in the HTML document.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An Internet-based information search apparatus, comprising:
a Resource Of A Resource (ROAR) name server for managing a resource name and a Uniform Resource Locator (URL) corresponding to the resource name, and transmitting URL information corresponding to contextual information, which contains the resource name, to a domain name server when the contextual information is received;
the domain name server for receiving the URL information and then transmitting an Internet Protocol (IP) address corresponding to the URL information to the ROAR name server; and
an input module for receiving the contextual information, which contains the resource name, transmitting the contextual information to the ROAR name server through a web browser, receiving the IP address from the ROAR name server, and requesting corresponding information from a web server.

2. The Internet-based information search apparatus according to claim 1, wherein the ROAR name server comprises a URL information conversion module for receiving a resource name from a user and converting the resource name into URL information.

3. The Internet-based information search apparatus according to claim 1, wherein the resource name includes a protocol part in which ‘roar’, or a symbol and alphabet letters corresponding to ‘roar’ are represented, and a symbol

4. The Internet-based information search apparatus according to claim 1, wherein the contextual information is profile information of a user, or an electronic document previously created by the user.

5. The Internet-based information search apparatus according to claim 1, wherein the ROAR name server comprises a resource name table in which information about mapping between a resource name and a plurality of URLs corresponding to the resource name is stored.
